(19) United States
(12) Patent Application Publication
(10) Pub. No.: US 2026/0270561 A1
(43) Pub. Date: Sep. 10, 2026

(54) METHOD AND DEVICE FOR CAPTURING IMAGES OF A MOVING SUBJECT

(71) Applicant: IDEMIA PUBLIC SECURITY FRANCE, Courbevoie (FR)

(72) Inventors: Ngoc-Son-Dorian NGUYEN, Courbevoie (FR); Yannick LOITIERE, Courbevoie (FR)

(73) Assignee: IDEMIA PUBLIC SECURITY FRANCE, Courbevoie (FR)

(21) Appl. No.: 19/461,895

(22) Filed: Jan. 28, 2026

(30) Foreign Application Priority Data
Mar. 5, 2025 (FR) FR2502205

(51) Int. Cl. H04N 23/695; G06V 40/18; H04N 23/60; H04N 23/611; H04N 23/617

(52) U.S. Cl. CPC H04N 23/695; G06V 40/193; H04N 23/611; H04N 23/617; H04N 23/64

(57) ABSTRACT

A method is provided for capturing images of a region of interest of a moving subject. The method includes steps of computation, repeated at a computation frequency, of the three-dimensional position of the region of interest in the capture volume; estimation of a three-dimensional path of the region of interest from the computed positions, the path being defined by a parametric path model combining a periodic and linear temporal component; determination of a position of the region of interest at least at one future time t_{capture} from the estimated path; and capture of an image of the region of interest with the capture camera pointing in the direction of the determined position of the region of interest at the time t_{capture}.

The present invention relates to the field of capturing images of a region of interest located on a moving subject. More particularly, the invention relates to tracking and obtaining a sharp image of the region of interest located on a moving person.

In a first example, it may be a question of recognizing the irises of a person passing in front of the image-capturing system, in the case of biometric recognition of a moving person. In a second example, it may also be a question of reading information, such as a two-dimensional code or QR code, of a badge worn by a moving person. Other examples of technical contexts may benefit from the invention.

Systems allowing the region of interest to be captured when the subject is stationary already exist. The capture volume is the region of space considered when capturing the image of the region of interest. It is the region in which the subject is able to move while images of the region are able to be captured. If the subject exits the capture volume, they are no longer visible to the image-capturing system.

When the subject is stationary, the image-capturing system may operate according to the following principle. In a first step, the subject is detected and located within the capture volume. Next, the image-capturing system waits for the subject to stabilize. When the subject is stable, an exact step of locating the region of interest makes it possible to obtain the coordinates thereof in three dimensions. These coordinates then allow the capture camera, which is equipped with motors allowing its orientation, to be positioned in the exact direction of the targeted region of interest. A succession of images is then captured until the obtained quality is sufficient for the application, typically iris recognition or read-out of information. It will be noted that the envisioned applications require an image of high resolution to be captured, irrespectively of whether it is for iris recognition or read-out of information.

When the subject is moving, capturing sharp images of the region of interest becomes more difficult. Specifically, the movement of the subject may generate blurry images. In addition, due to the required resolution and sensitivity, the captured images have a very shallow depth of field. An inaccuracy in the distance of the region of interest then also results in capture of a blurry image. Furthermore, it has also been observed that when capturing an image of an iris at short range, and in particular at less than one meter, pointing becomes tricky, since the movement of the person can no longer be compensated for by the field of the camera, and the target exits the field of the capture camera. Similarly, at short range, it has been observed that the temporal latency between detection of the eyes and the control of movement of the capture camera by its motors can have a substantial impact on the accuracy of the estimated position. These drawbacks may result in failure when attempting to track at short range or high walking speed.

The invention aims to solve all or some of these problems by proposing a method for capturing images of a region of interest of a moving subject that allows acquisition, in a reliable manner, of a sharp image of the targeted region of interest of the moving subject, in particular at short range (for example at less than one meter, and in particular up to 70 cm from the capture camera) including when the subject is walking at high speed (for example at more than 1 m/s, and in particular up to 1.5 m/s).

According to one aspect of the invention, a method for capturing images of a region of interest of a moving subject within a capture volume is proposed, the method comprising the following steps:
computation, repeated at a computation frequency, of a three-dimensional position of the region of interest, delivering as output a sequence of three-dimensional positions of the region of interest, on which an instantaneous observable position signal depends, from a series of acquired images in which the region of interest is detected and located;
extraction, at an application frequency, of a periodic observable signal from the instantaneous observable position signal;
estimation of a three-dimensional path of the region of interest in the capture volume from the computed positions, the path being defined, in at least one dimension, by a parametric path model combining a periodic temporal component and a linear temporal component;
determination of a position of the region of interest at least at one future time t_{capture} from the estimated three-dimensional path of the region of interest;
capture, at the time t_{capture}, of an image of the region of interest by a capture camera with the capture camera pointing in the direction of the determined position of the region of interest at the time t_{capture}.

This method allows a sharp image of the region of interest of a moving subject to be captured, including at short range, with a short tracking time during which a sequence of three-dimensional positions of the region of interest is obtained after detection and location. Furthermore, this method makes it possible to compensate for latencies. Thus, the number of images of the subject that are captured by the capture camera is reduced, capture by the capture camera of a single image of the subject possibly even sufficing, due to the obtained image quality, for the application, in particular biometric application, the capture of a succession of images of the subject by the capture camera no longer necessarily being required. Furthermore, this method allows multiple subjects to be tracked in parallel.

In particular, the motion of the subject is a walking motion, the speed of which is in particular less than 2 m/s, and particularly between 1 and 1.5 m/s, the method therefore being suitable for average walking speeds but also hurried walking speeds.

Advantageously, the acquired images are images of a detection volume, which are acquired by a context camera system, and which are also called context images, this allowing tracking by the context camera, during which tracking a sequence of three-dimensional positions of the region of interest in the detection volume is obtained after detection and location. Similarly, if multiple subjects are present in the detection volume and appear in the context images, one region of interest per subject will be tracked.

Advantageously, if the acquisitions are carried out at a given acquisition frequency, the computation frequency is in particular less than or equal to said acquisition frequency.

Advantageously, the estimation is carried out at an estimation frequency, preferably equal to the computation frequency.

Advantageously, images are captured by a capture camera in the capture volume at a capture frequency.

Advantageously, the detection volume, which corresponds to the segment of the field of the context camera system in which the acquired image quality is sufficient to carry out object detection (for example of depth greater than 2 meters from the context camera system, and preferably 2.50 meters), and the capture volume, which corresponds to the segment of the field of the capture camera in which the captured image quality is sufficient to achieve recognition of the region of interest, have a common portion, this making it possible to work with a detection volume having a depth greater than the depth of the capture volume, which is in particular constrained by the high resolution required for iris acquisition in the context of biometric recognition (for example depth between 1.50 meters and 0.50 meters from the capture camera in the case of iris recognition). The large depth of the detection volume allows tracking such that the model will have already converged before the subject enters the capture volume, given that initialization for example occurs on a half step movement, i.e. of about 50 centimeters.

Preferably, the instantaneous observable position signal is made up of the sequence of positions computed for the region of interest.

Advantageously, the periodic temporal component of the path model comprises an amplitude parameter, a phase parameter and an angular-frequency parameter, allowing a periodic sinusoidal temporal component to be represented. In a manner equivalent to this spectral angular-frequency decomposition, a frequency decomposition is possible.

Advantageously, the linear temporal component of the path model comprises a rate-of-change parameter and an intercept parameter.

Advantageously, one of said at least one dimension is the vertical dimension (y), this allowing the height of the region of interest of a moving subject to be accurately modeled, in particular by taking into account its up-down rhythm, this being especially important to pointing the capture camera in the direction of the determined position of the region of interest, especially when the subject is walking.

Advantageously, one of said at least one dimension is the lateral dimension (x), this allowing the horizontal left-right lateral swaying motion (motion in the x-direction) of the region of interest of a moving subject to be accurately modeled, especially when the subject is walking.

Similarly, said at least one dimension may designate both the aforementioned dimensions because the step, i.e. the gait, of a subject includes not only an up-down vertical motion (in the y-direction) but also a left-right swaying motion (in the x-direction).

Advantageously, one of said at least one dimension is the longitudinal dimension (z), this allowing the horizontal longitudinal depthwise motion (motion in the z-direction) of the region of interest of a moving subject to be accurately modeled, especially when the subject is walking. Specifically, to a lesser extent the path in the depth dimension (z) may also be thus modeled, this achieving a better estimation than a linear approximation alone because the gait of a subject follows a specific rhythm that, for example, varies depending on the supporting leg, the motion resulting from which, in particular when the person limps, is not necessarily symmetrical, creating a back-and-forth rocking effect with each step.

Thus, said at least one dimension may advantageously designate all three of the aforementioned dimensions so as to allow the location of the region of interest in said three dimensions to be accurately estimated.

Advantageously, pointing of the capture camera is accompanied by adjustment of the focus of the capture camera as a function of the distance between the capture camera and the determined position of the region of interest at the time t_{capture}, this making it possible to improve the sharpness of the obtained image, in particular if the depth of field of the lens of the capture camera is not sufficiently wide. Advantageously, the adjustment and pointing may be carried out simultaneously.

Advantageously, the focus of the capture camera is adjusted depending on the distance between the capture camera and the determined position of the region of interest at the time t_{capture} plus a focus factor that varies in set or variable steps in an interval, in particular one centered on zero, this allowing a focus ramp to be achieved.

Advantageously, the focus factor varies linearly between the extreme values of the zero-centered interval.

Advantageously, the focus factor varies sinusoidally between the extreme values of the zero-centered interval.

Advantageously, the focus factor varies in increments corresponding to the depth of field between the extreme values of the zero-centered interval.

In one embodiment, the subject is a person, the region of interest being a portion of a face of the moving subject, including an eye, preferably an iris, or being a visual representation (pictogram) worn by the subject, such as a two-dimensional bar code.

Advantageously, the capture frequency of the capture camera is greater than the frequency of acquisition by the context camera system.

In one embodiment, the step of estimation of the path comprises implementation, for the detected region of interest of the subject, of an extended Kalman filter of the parametric path model in said at least one dimension, this comprising a phase of initialization of the extended Kalman filter, a phase of prediction by the extended Kalman filter and a phase of update of the extended Kalman filter at a sampling frequency. The extended Kalman filter makes it possible to linearize locally the non-linear component of the parametric path model for the region of interest in question. The extended Kalman filter makes it possible to simultaneously make a prediction (future value) and denoise the models with non-linear equations, something that is particularly useful when it is considered that the instantaneous observable position signal may be decomposed into a combination of a linear function, of a sinusoidal function and of measurement noise. In particular, if a plurality of subjects are detected, the step of estimation of the path comprises implementation, for the detected region of interest of each subject, of an extended Kalman filter of the parametric path model in said at least one dimension.

The computed or determined positions and said estimated path are preferably in, or transposed to, a frame of reference belonging to the capture camera.

In particular, the determination of the position of the region of interest at least at one future time t_{capture} from the path estimated through implementation of an extended Kalman filter is carried out only if said Kalman filter has converged.

Advantageously, the path estimation frequency is the same as the sampling frequency of the extended Kalman filter, which frequency is also called the update frequency of the extended Kalman filter, and less than or equal to a frequency of acquisition of context images by the context camera system, which itself is preferably greater than or equal to said computation frequency, i.e. the frequency of computation of the three-dimensional position of the region of interest from the series of acquired context images.

Advantageously, the three-dimensional path of the region of interest is estimated at a frequency equal to the frequency of computation of the three-dimensional position of the region of interest, this allowing the computations to be synchronized. As a variant, the sampling frequency of the extended Kalman filter may be variable, for example in the case of a context camera system comprising a multiplicity of sensors the data of which are fused, and that have different frequencies, the position computations hence not necessarily occurring at synchronized times, and the filter is preferably updated with each new computed position, such a device and method in particular making it possible to limit concealment in the detection volume, by virtue of the fusion of sensor data.

Advantageously, the frequency of computation of the position varies over time, this making it possible to adapt to the availability of sensor measurements, in particular if a target is momentarily concealed—for example, in the context of iris acquisition, the person could turn their head, which would make their eyes disappear from the field of acquisition, or a change in the exposure time of the context camera system could occur depending on lighting conditions. Similarly, this also makes it possible to mitigate image loss due to overload of the central processing unit of the data-processing device implementing the invention. For example, in case of non-detection of the region of interest in an image, the frequency of computation of the position may be decreased. Thus, the update frequency of the extended Kalman filter is variable, depending on whether or not the region of interest is detected in the acquired images, the extended Kalman filter not being updated in computation cycles in which the region of interest has not been detected in the acquired image in said cycle, thus avoiding computations.

In one embodiment, the method comprises a step of application, at an application frequency, of a band-pass filter in said at least one dimension to the instantaneous observable position signal with a view to extracting the periodic observable signal.

In particular, the periodic observable signal is centered on zero, this resulting from the application of the band-pass filter and achieving compatibility with the periodic temporal component of the zero-centered path model.

Advantageously, the update frequency of the extended Kalman filter is equal to the application frequency of the band-pass filter.

In particular, the application frequency of the band-pass filter is variable, this making it possible to cope with cases of concealment of the subject, i.e. when the three-dimensional position cannot be computed in certain acquired images. Advantageously, the band-pass filter is biquadratic, allowing customized and robust implementation.

Advantageously, the coefficients of the band-pass filter are determined experimentally, based on tests carried out on a sample of subjects (in particular at varied walking speeds) whose average oscillation frequency (in the y-direction) preferably varies between 1 and 2 Hz, by spectral analysis of the data thus obtained.

In one embodiment, the extended Kalman filter is based on a measurement vector containing at least two observers, having as first observer the instantaneous observable position signal, which is made up of the sequence of computed positions of the region of interest, and as second observer the periodic observable signal.

In one embodiment, a state vector of the extended Kalman filter contains five states, namely an average position of the region of interest in said at least one dimension, a rate of change in the average position of the region of interest in said at least one dimension, an amplitude of oscillation of the region of interest around the average position, a phase of oscillation around the average position and an angular frequency of oscillation of the average position of the region of interest. For example, in the case of application to an iris, in the case of a parametric path model in the dimension y only, the states listed above for example correspond to the height of the person's eyes, to the rate of change in this height (excluding any oscillation (“linear” component)), to the amplitude of the oscillation of the height of the eyes, to the phase of the sinusoid modeling this oscillation around the average height of the eyes and to the rate of change in this phase, i.e. the angular frequency of oscillation, in particular resulting from the pace of the steps of the person. This composition of the states makes it possible to improve accuracy by increasing fidelity to parameters describing gait. Equivalently, the angular frequency and phase may be replaced by a frequency and phase.

In one embodiment, the phase of initialization of the extended Kalman filter comprises determining an initial state vector through determination of initialization parameters comprising:
an amplitude parameter;
a phase parameter;
an angular-frequency parameter;
a rate-of-change parameter;
an intercept parameter;
   said initialization parameters being determined from all or part of the sequence of computed three-dimensional positions of the region of interest. In particular, for said region of interest, a single initialization phase is sufficient, including in the case of temporary concealment of the subject in one or more images.

Advantageously, said part of the sequence comprises at least two positions computed on the basis of images acquired successively by the context camera system, and for example comprises the first n computed three-dimensional positions of the region of interest, with n in particular being greater than or equal to 4, and for example 8, particularly for a subject whose step frequency is substantially one hertz.

In one embodiment, said part of the sequence of positions comprises the positions computed for said region of interest on the basis of successively acquired images, the first image of which is the one in which the region of interest is detected a first time, and the following images of which are those in which the region of interest is detected, until at least two local extrema are detected, this allowing the end of a step movement to be reached and initialization to occur on at least one half step movement, the middle of the step movement for example being considered to correspond to a local maximum and the end of the step movement to correspond to a local minimum (or vice versa). This embodiment therefore allows a robust initialization appropriate for a multidimensional path model.

In one embodiment, a covariance matrix of the process noise of the extended Kalman filter depends on the sampling period of the extended Kalman filter and on at least one variance of the rate of change in the average position of the region of interest in said at least one dimension, a variance of the angular frequency of oscillation of the region of interest around the average position of the region of interest or a variance of the amplitude of oscillation of the region of interest around the average position of the region of interest. Thus, the covariance matrix of the process noise of the extended Kalman filter depends on the sampling period of the extended Kalman filter and on at least one variance of the representative rate of the moving subject, of the period of oscillation representative of the motion of the moving subject or of the amplitude of oscillation representative of the motion of the moving subject. Said variances are preferably pre-calibrated empirically (for example on the basis of a statistical pre-study) and/or depend on positions of the region of interest that are computed before the prediction phase.

Preferably, the covariance matrix of the process noise of the extended Kalman filter depends on the sampling period of the extended Kalman filter and on all three variances.

In one embodiment, the estimation of the path of the region of interest at an arbitrary future time t_{tracking} is obtained by computing a tangent to the modeled path at said arbitrary future time t_{tracking} and the parameters of which result from the update of the extended Kalman filter on the basis of images acquired prior to the estimation, in particular with the modeled path written in terms of position pos and speed spd as:

$$pos ( {t}_{tracking} ) = {P}_{average path} ( {t}_{measure position} ) + {drift}_{average path} * ( {t}_{tracking} - {t}_{measure position} ) + Amplitude * sin ( Φ ( {t}_{measure position} ) + ω * ( {t}_{tracking} - {t}_{measure position} ) )$$

$$spd ( {t}_{tracking} ) = {drift}_{average path} + Amplitude * ω * cos ( Φ ( {t}_{measure position} ) + ω * ( {t}_{tracking} - {t}_{measure position} ) ) ,$$

with t_{measure position} the time at which the last context image used to estimate the path is acquired, the tangent to the parametric model being written:

$$pos ( t ) = pos ( {t}_{tracking} ) + spd ( {t}_{tracking} ) * ( t - {t}_{tracking} ) ,$$

this making it possible, by applying t=t_{capture}, to obtain the determination of the position of the region of interest at the future time t_{capture}.

The arbitrary future time t_{tracking} is advantageously an estimated time of receipt of the path by the real-time coprocessor, this making it possible to take into account the latency between the real time and the times of acquisition of the context images.

In one embodiment, the capture camera is pointed in the direction of the position of the region of interest determined depending on the three-dimensional path of the region of interest at a frequency higher than the computation frequency, this allowing the pointing direction to be changed at a rate greater than the position computation frequency and real-time tracking to be carried out on the basis of the latest estimation of the path of the region of interest at t_{tracking}.

Advantageously, the context camera system comprises two cameras producing stereoscopic images.

Advantageously, the context camera system comprises a time-of-flight camera.

According to another aspect of the invention, a computer program comprising instructions configured to implement each of the steps of the method according to the invention when said program is executed on a computer is proposed.

According to another aspect of the invention, a removable or irremovable information storage means that is partially or totally readable by a computer or a microprocessor is proposed, said means containing code instructions of a computer program for executing each of the steps of the method according to the invention.

According to another aspect of the invention, a device for capturing images of a region of interest of a moving subject within a capture volume is proposed, the device comprising:
a context camera system;
a capture camera;
a processor configured for the following steps:
   computation, repeated at a computation frequency, of a three-dimensional position of the region of interest, delivering as output a sequence of three-dimensional positions of the region of interest, on which an instantaneous observable position signal depends, from a series of images acquired by the context camera system and in which the region of interest is detected and located;
   extraction, at an application frequency, of a periodic observable signal from the instantaneous observable position signal;
   estimation of a three-dimensional path of the region of interest in the capture volume from the computed positions, the path being defined, in at least one dimension, by a parametric path model combining a periodic temporal component and a linear temporal component;
   determination of a position of the region of interest at least at one future time t_{capture} from the estimated three-dimensional path of the region of interest;
   capture, at the time t_{capture}, of an image of the region of interest with the capture camera pointing in the direction of the determined position of the region of interest at the time t_{capture}; this allowing the capture camera to be pointed in the direction of the determined position of the region of interest at the time t_{capture}, and an image to be captured by the capture camera at the time t_{capture}, and having the same advantages as the method according to the invention.

In one embodiment, the capture camera is rotatable so as to point in the direction of the determined position of the region of interest in said at least one dimension.

Advantageously, the context camera system comprises two cameras producing stereoscopic images.

Advantageously, the context camera system comprises a time-of-flight camera.

The invention will be better understood by virtue of the following description, which refers to embodiments and variants according to the present invention that are given by way of non-limiting examples and explained with reference to the appended drawings, in which:

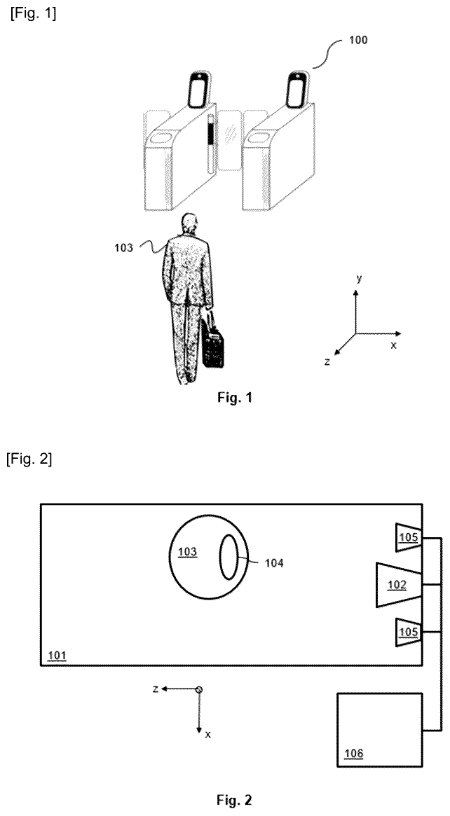

FIG. 1 shows an image-capturing device according to one embodiment of the invention in one context of application;

FIG. 2 shows a diagram of an architecture of the image-capturing device according to one embodiment of the invention;

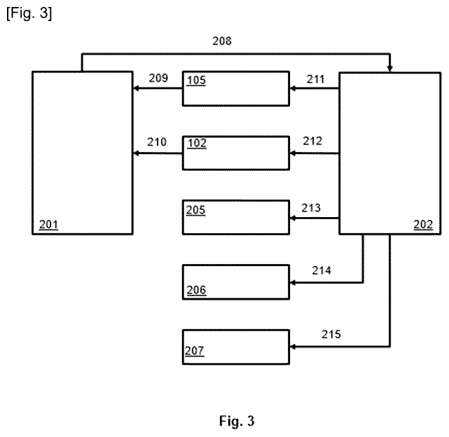

FIG. 3 shows a diagram of a hardware architecture of an image-capturing device according to one example of embodiment of the invention;

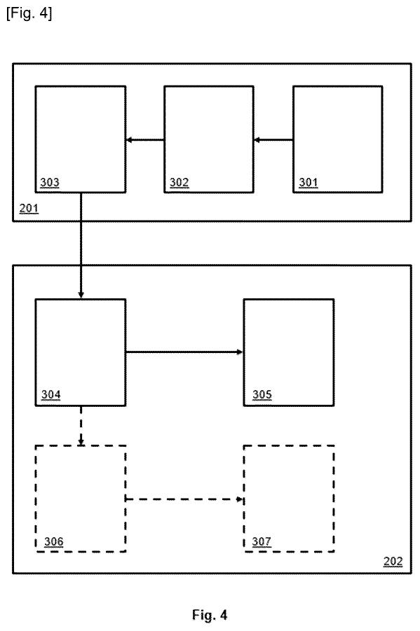

FIG. 4 shows a software architecture used for path estimation and tracking in one example of embodiment of the invention;

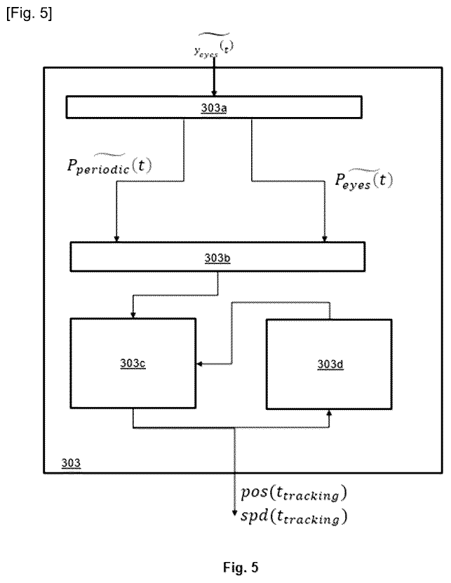

FIG. 5 shows the principle of path estimation in one example of embodiment of the invention;

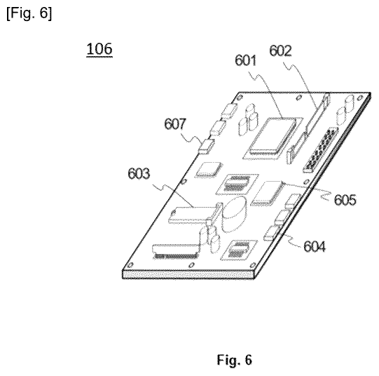

and FIG. 6 is one example of a layout of a data-processing device that may be used to implement one or more embodiments of the invention.

Identical references have been used in all the figures to designate elements that are identical or similar, in their form or function.

The invention is applicable to various contexts. It may be a question of recognition of the irises of a moving person 103 passing in front of an image-capturing device 100, or even of recognition of a badge worn by a moving person 103 passing in front of an image-capturing device 100, for example with the aim of permitting or preventing said person from gaining access and/or of timestamping their entry. The subject may, for example, be passing through a security gate (such as in an airport, a virology laboratory or a nuclear power plant) or simply be moving about in a free space (such as a public space) and be tracked by the image-capturing device. Another example of embodiment of the invention relates to capture of a two-dimensional code or QR code (QR standing for Quick Response) placed on an object that is being moved about by a moving person, in particular one who is walking, in particular during delivery or handling. It is then a question of capturing images of the code of the object while it is being handled, typically in a warehouse. In each and every case, it is a question of capturing a sharp image of a region of interest located on or worn by a moving subject.

The embodiment of FIG. 1 pertains to the context of recognition of the irises of a moving person 103 passing in front of an image-capturing device 100 according to one embodiment of the invention, arranged in an airport. The acquisition in motion of the irises of the person 103 allows the person to be recognized and authenticated upstream of the device 100, this for example allowing a security gate that would otherwise prevent access to be opened if the person is recognized as being permitted entry, and where appropriate a record of their entry to be kept, without the person having to stop in particular, making entry fluid and fast, the person being able to maintain their walking speed.

FIG. 2 illustrates the architecture of the device 100 according to one embodiment of the invention. This figure illustrates the capture volume 101 equipped with a capture camera 102. The capture camera 102 advantageously makes it possible to capture an image of a subject 103 having a region of interest 104. To do this, the capture camera 102 is typically motorized to allow it to be oriented in space. In the example of embodiment, it is equipped with two motors one of which allows rotation in the horizontal plane and the other of which allows rotation in the vertical plane. The movement of these two motors makes it possible to point the capture camera in any direction within the capture volume 101. A third motor adjusts the focus of the capture camera, i.e. adapts the image capture to the distance of the subject from the capture camera, and more particularly to the distance of the region of interest 104 of the subject 103 from the capture camera, this distance here corresponding to a depth.

The image-capturing device 100 is controlled by a data-processing device 106 that allows the movements of these motors to be controlled. Typically, but not necessarily, it is also this data-processing device 106 that receives and processes the images received from the capture camera 102. The data-processing device is typically a computer, a tablet, a smart phone or any other device allowing a computer program responsible for controlling the camera, acquiring images and for the various steps of the method according to the invention to be executed.

In a reference embodiment, the capture camera 102 is supplemented by a context camera system, in particular comprising one or more context cameras 105, the distance from the subject possibly being computed by triangulation using at least two context cameras 105. This context camera system makes it possible to capture images of the detection volume, which covers all or part of the capture volume, then to recognize a subject 103 in the acquired image before locating them, then to locate the region of interest 104 of the subject. In certain embodiments, the context camera system is also controlled by the data-processing device 106. Alternatively, a dedicated device may be responsible for controlling the context camera system. In this case, this device communicates with the device 106 with a view to capturing images. The context camera system may, as a variant, or in addition to a context camera, comprise a time-of-flight (ToF) sensor, a radar or any other sensor able to contribute to locating the subject. The context cameras and their optional ancillary sensors make it possible to compute the three-dimensional position of the subject 103 and more particularly of the region of interest 104 of the subject in space, and in particular in the detection and capture volumes.

This estimation of the position of the region of interest is used to position and adjust the capture of images by the capture camera. However, the acquisition of images by the context cameras 105, their analysis to determine the three-dimensional position of the region of interest, the computation of the motor controls allowing the capture camera 102 to be directed toward the computed position and the acquisition of images by the capture camera takes a certain time. There are therefore latencies between the computation of the position and the capture of the images of the region of interest. Due to the continuous movement of the subject, to these latencies and to the inherent inaccuracy of the positioning computation, obtaining a sharp capture image of the region of interest is a challenge.

According to the invention, provision is made to control the capture camera depending, not on the position of the region of interest computed by the context cameras, but on an estimation of where this position will be when an image of this region of interest is actually captured by the capture camera. The estimation of position is therefore an estimation of a future position of the region of interest at the time of its estimation. It is made based on computed actual positions allowing the path of the subject 103 to be estimated and therefore their position in the future, at the moment when the capture camera will capture the image, to be determined. By path what is meant is the position, as a function of time, that models the motion as a function of time—in other words, the path of a point is the geometrical curve that it describes as it moves through the frame of reference and it therefore provides information on position and speed over time in the frame of reference. To determine this future position, a three-dimensional path of the region of interest 104 is estimated from the computed positions; the path is, in at least one dimension, defined by a parametric path model combining a periodic temporal component and a linear temporal component. It will thus be understood that the future position is determined with a high accuracy apposite to the movement of the subject, whether the latter is walking or in a wheelchair for example, by virtue of the combination of the two components. Specifically, if the person is in a wheelchair, the periodic component of the parametric model will be estimated to be zero.

Where appropriate, focusing may be carried out, the determined three-dimensional position then being modified by a focus factor in the dimension representing the distance of the region of interest from the capture camera. This focus factor represents the addition of a value that varies linearly between a negative minimum and a positive maximum around the value of zero and changes between each image capture. Adjusting the focus of the image captures slightly in this way increases the chances of obtaining at least one sharp image in a set of captured images.

Advantageously, the motors with which the capture camera is equipped are brushless motors, and in particular direct drive motors (allowing continuous motor movement). Brushless motors allow smooth, continuous tracking by the capture camera of the motion of the subject, without compromising image quality. When the motors are direct-drive motors, the absence of reduction gears specific to these motors eliminates the associated mechanical play. This would not be possible with stepper motors controlled using a stepped control method, as used in known systems.

FIG. 3 illustrates the hardware architecture of an image-capturing device 100 according to one example of embodiment of the invention. The image-capturing device 100 is mainly controlled by the main processor 201, which is preferably, but not necessarily, hosted in the data-processing device 106. This processor 201 is typically operated by a conventional operating system such as Linux®, Windows® or MacOS®. These operating systems are not strictly real-time, potentially affecting the accuracy of the estimations, and this must be taken into account.

The image-capturing device 100 also comprises a coprocessor 202, which is preferably, but not necessarily, hosted in the data-processing device 106. The main characteristic of this coprocessor 202 is that it is real-time, i.e. able to execute certain tasks at precise predetermined times, in a guaranteed manner. The real-time coprocessor 202 is responsible for triggering 211 the context cameras 105, triggering 212 the capture camera 102, controlling 213 the motor 205 for focusing the capture camera, controlling 214 the aiming motors 206 that allow the capture camera to be oriented, and finally controlling 215 illumination 207 of the region of interest synchronously with the capture of images by the capture camera. The images 209 generated by the context cameras 105 and the images 210 generated by the capture camera 102 are transmitted for processing to the main processor 201.

The real-time coprocessor 202 is responsible for real-time tasks. It triggers acquisition of the images by the context camera system 105 at regular intervals, for example at a frequency preferably greater than 7 Hz and equal in the example of embodiment described here to 15 Hz. It controls the movements of the aiming motors, for example via servo-control of position and/or speed. It controls the movements of the focus motor. It triggers image capture by the capture camera 102 at the right time, and activates illumination of the region of interest synchronously with capture by the capture camera 102.

The main processor 201 receives a stream of images acquired by the context cameras 105. In these acquired images, also called context images, it detects the presence of the subject 103 and locates in three dimensions the region of interest 104 in the detection volume. On the basis of these three-dimensional coordinates, the main processor estimates the path of the region of interest and then sends the path to the coprocessor 202.

The coprocessor 202 servo-controls the position and speed of the aiming motors 206 so as to reach as quickly as possible the path sent to it by the main processor 201.

When the aiming motors have “locked onto” the ideal path and point in the direction of the determined position of the region of interest at the time t_{capture}, the coprocessor 202 triggers capture of the image of the region of interest by the capture camera 102 at the time t_{capture}, this capture possibly being repeated, in particular periodically, for example in the event of concealment of the subject at the time t_{capture}.

The more often the coprocessor 202 receives path updates, the closer it will get to the actual path of the region of interest.

The advantage of the synchronization between the main processor and coprocessor is that transmission of commands by the main processor is not subject to real-time constraints, this allowing a multi-task non-real-time operating system to be used. In other alternative embodiments, a single real-time processor handles all of the tasks here shared between the central processor and the real-time coprocessor.

FIG. 4 illustrates the software architecture used for path estimation and tracking in one example of embodiment of the invention.

The example of embodiment is based on the use of two context cameras 105 used in a stereoscopic mode to allow three-dimensional location of objects detected in the image. It will be noted that other embodiments may use other techniques, alternatively or in addition to stereoscopic imaging, such as time-of-flight cameras, or even a system for achieving three-dimensional vision based on structured light.

The main processor 201 executes a first module 301 that is responsible for locating the region of interest, for example the eyes of the subject in the case of recognition of irises within the context images. The recognition and location algorithm used is known per se and is not a subject of this document.

A second module 302 executed by the main processor 201 is responsible for computing the three-dimensional position of the region of interest located by the first module. Preferably, the frequency at which the three-dimensional position of the region of interest is computed is less than or equal to the frequency of acquisition by the context camera, for example 15 Hz, the advantage of computing a position at a frequency less than the acquisition frequency of the images being to decrease the load on the processor at times of high demand—the computation frequency may therefore advantageously be varied depending on load. These positions are stored in memory, or at least the latest few are stored in memory. The number of positions stored in memory with a view to estimating the path, which is defined in at least one dimension by a parametric path model combining a periodic temporal component and a linear temporal component, is at least two positions. Preferably, the constituent positions of a complete step of the subject are used in the initialization phase of the extended Kalman filter employed to estimate the path.

A third module 303 executed by the main processor 201 is responsible for estimating the path of the region of interest. The path is estimated as a function of time. To do this, the received context images are time-marked with a timestamp when they are received. These timestamps allow a time index n to be associated with the computed three-dimensional positions. The time index n corresponding to a time t therefore corresponds to the three-dimensional position Pₙ=(Xₙ, Yₙ, Zₙ). A sequence of indexed positions Pᵢ is thus obtained. The path model P_{eyes}(t) comprises:
a periodic temporal component P_{periodic}(t) that is dependent on an amplitude parameter Amplitude, a phase parameter do and an angular-frequency parameter ω_{walk}. Equivalently to this angular-frequency spectral decomposition, a frequency decomposition is possible
a linear temporal component Pₗᵢₙₑₐᵣ(t) dependent on a rate-of-change parameter drift_{average path} and on an intercept parameter P_{average path}.

The parametric path model P_{eyes}(t) of the eyes, in three dimensions, is written:

$${P}_{eyes} ( t ) = {P}_{linear} ( t ) + {P}_{periodic} ( t )$$

Pₗᵢₙₑₐᵣ(t)=P_{average path}(t), which corresponds in this example to the average position of the eyes excluding any oscillation over time, i.e. to the average position of the two eyes as a function of time excluding any oscillation, here in three dimensions, and with P_{average path}(t)=P_{average path}+drift_{average path}*(t−t₀);
and P_{periodic}(t)=Amplitude*sin(Φ(t)), which corresponds in this example to the oscillation of the average position of the eyes over time, i.e. to the oscillation of the average position of the two eyes as a function of time, here in three dimensions, and with Φ(t)=Φ₀+ω_{walk}*(t−t₀).

In order to separate the linear component from the periodic component of the instantaneous observable position signal, a band-pass filter, which may be different depending on the dimensions, is applied to the instantaneous observable position signal made up of the computed positions of the eyes over time.

An extended Kalman filter is used to estimate this parametric path model. The extended Kalman filter is based on:
a measurement vector

$$Z ( t ) = \{ \begin{matrix}\text{?} \\ \text{?}\end{matrix}$$

containing two observers, the first observer of which is the instantaneous observable position signal [symbol] , which consists of the sequence of computed eye positions, and the second observer of which is the periodic observable signal [symbol] ;
a state vector

$$x ( t ) = \{ \begin{matrix}{P}_{average path} ( t ) \\ \dot{{P}_{average path}} ( t ) = {drift}_{average path} \\ Amplitude \\ Φ ( t ) \\ \dot{Φ ( t )} = ω\end{matrix}$$

containing five states including an average position P_{average path}(t) of the region of interest in each dimension, a rate of change P_{average path}(t) in the average position of the region of interest in each dimension, which therefore corresponds to a representative rate of the moving subject corresponding to the change between two measurement times in the speed of a moving subject (excluding any oscillation), an amplitude of oscillation Amplitude of the region of interest around the average position, a phase Φ(t) of oscillation around the average position and an angular frequency Φ(t) of oscillation of the average position of the region of interest. Thus in this example, the states listed above correspond to the height of the person's eyes (P_{average path}(t)), to the rate of change in this height (excluding any oscillation (“linear” component)) (P_{average path}(t)), to the amplitude of the oscillation of the height of the eyes (Amplitude), to the phase of the sinusoid modeling this oscillation around the average position (Φ(t)) and to the rate of change in this phase (Φ(t)), i.e. the angular frequency of oscillation, which in particular is related to the pace of the steps of the person. The amplitude of the oscillation is in particular related to the morphology and gait of the person. Selecting such states makes it possible to increase accuracy by increasing fidelity to parameters describing the person's gait, the first two states relating to the linear part of the prediction and the last three to the periodic part of the prediction. It will be noted that, equivalently, the angular frequency and phase may be replaced by a frequency and phase.
   For each new subject, the path of their eyes P_{eyes}(t) is estimated by means of a parametric model, through implementation of an extended Kalman filter of the parametric path model in each dimension, this comprising a phase of initialization of the extended Kalman filter, a phase of prediction by the extended Kalman filter and a phase of update of the extended Kalman filter at a sampling frequency. The following illustration will now be used to explain in more detail how this path estimation step is implemented. In the case presented here, only a single path of the eyes is modeled per person because the modeled path is that of a point halfway between the two eyes, the field of the capture camera allowing both eyes to be acquired at the same time, because the camera advantageously comprises two sensors with two lenses that share the same motor; nevertheless, it would be possible to compute the path of each eye and to update the path of each eye in parallel.

Advantageously, in the case where the acquired images contain a plurality of regions of interest, for example in the case where a plurality of subjects (each with one region of interest) are detected in the acquired images, the paths of the regions of interest (including in particular filter updates) may be estimated in parallel, the images of each region of interest then possibly being captured sequentially, in particular if there is only one capture camera 102.

The path-estimating module 303 transmits the successive estimations to a path-tracking module 304 executed by the real-time coprocessor 202. The path-tracking module is capable of determining the position of the region of interest, at any time, on the basis of the last path estimation transmitted by the module 303, so as to ensure continuous optimized pointing. In practice, the frequency of transmission of the successive estimations is generally greater than the frequency of capture of the context images. In this example, the path estimations are transmitted at a frequency of 15 Hz, then in the real-time coprocessor the path-tracking module is responsible for determining the position of the region of interest at a frequency of 1 kHz, on the basis of the last path estimation transmitted by the module 303, this guaranteeing continuity in the pointing of the capture camera to disengagement from the path, even though the capture frequency is here 15 Hz, or variable. Specifically, if the captured image is suitable for biometric recognition of the subject, another capture is not necessary.

This ability to determine the position of the region of interest at any time makes it possible to control the module 305 for controlling the motors used to aim the capture camera 102. This is how the capture camera 102 continuously tracks the region of interest.

A module 306 also receives the determined position of the region of interest. This module 306 is responsible for computing a focus factor that is added to the depth coordinate (Z) of the determined position, i.e. to the distance between the capture camera and the region of interest. The focus factor varies, for example linearly, between a negative minimum and a positive maximum. The distance between the capture camera and the determined position of the region of interest, corrected by the focus factor, allows the module 307 that controls the motor used to focus the capture camera 102 to be controlled. The modules 306 and 307 have been drawn with dashed lines because they are optional, the device 100 being able to operate without additional focusing, in particular if the depth of field of the lenses of the capture camera is sufficiently wide relative to the error in the position prediction, a few centimeters for example when EDOF sensors are used (EDOF standing for Extended Depth of Focus).

Optionally, the third module 303 is responsible for an additional estimation of the path of the region of interest. In the phase of prediction by the extended Kalman filter, as soon as the prediction error |Pk/k−1−Pk/k| of the extended Kalman filter, in relation to the computation of the actual position, drops below a convergence threshold, for example one determined statistically or dynamically, the extended Kalman filter is considered to have converged. Advantageously, as long as the extended Kalman filter has not converged the additional estimation is used, in particular during the initialization phase. This additional estimation is typically made through linear approximation of the stored positions. The simplest embodiment merely estimates the coordinates of a straight line passing through the last two stored positions. In this case, a locally rectilinear path is estimated, which may be sufficient. In more complex embodiments, it is possible to compute a polynomial model of the path based on a number of positions greater than two. Such a polynomial model makes it possible to obtain a path estimation that is more accurate than the locally rectilinear path. The path is estimated as a function of time. The sequence of indexed positions Pᵢ makes it possible to compute a speed associated with this position once at least two positions have been stored. This series may have indexes with which there are no positions associated. This may be due to a problem with transmission of context images, or to an inability to recognize the region of interest in certain context images for example. These missing positions must be taken into account when estimating the path, and in particular in the estimation of speed. For example, for a locally rectilinear path estimation based on two stored positions Pₙ₋₁=(Xₙ₋₁, Yₙ₋₁, Zₙ₋₁) and Pₙ=(Xₙ, Yₙ, Zₙ), it is possible to estimate the speed of the subject at the time t corresponding to time index n: Vₙ=(VXₙ, VYₙ, VZₙ)=(Xₙ−Xₙ₋₁, Yₙ−Yₙ₋₁, Zₙ−Zₙ₋₁). If position Pₙ₋₁ is missing, it is possible to use position Pₙ₋₂ in a similar way, though it is then necessary to divide the obtained speed by two to take into account the missing position. It is then possible to estimate a position at a time T greater than the current time t, from the current position at time t by applying the speed over a time (T−t).

FIG. 5 illustrates the principle of path estimation in one example of embodiment of the invention. For the sake of clarity, the description will be focused solely on parametric modeling of the path P_{eyes}(t) only in the y-dimension, which characterizes the height of the eyes of the subject, which is the most subject to periodic variation.

The dynamics of the eyes are modeled using the state equations of the system:

$$\{ \begin{matrix}\dot{x ( t )} = f ( x ( t ) , u ( t ) , w ( t ) ) transition equation \\ z ( t ) = h ( x ( t ) , v ( t ) ) observation equaiton\end{matrix}$$

either via Euler discretization, k denoting the time index:

$$\{ \begin{matrix}{x}_{k} = f ( {x}_{k - 1} , {u}_{k} , {w}_{k} ) \\ {z}_{k} = h ( {x}_{k} , {v}_{k} )\end{matrix}$$

with:
   xₖ the actual state,
   uₖ the input command, here zero given the absence of commands;
   wₖ the transition noise, which is a centered Gaussian of covariance matrix Qₖ
   zₖ measurement
   vₖ the measurement noise, which is a centered Gaussian of covariance matrix Rₖ;
   or by considering that P_{eyes}(t) is made up of P_{average path}(t)=P_{average path}+drift_{average path}*(t−t₀) and Pₗᵢₙₑₐᵣ(t)=P_{periodic}(t)=Amplitude*sin(Φ(t)), with Φ(t)=Φ₀+ω_{walk}*(t−t₀), so that in the case of variation of the position of the eyes along the y axis the following may be written:

$$\{ \begin{matrix}{y}_{eyes} ( t ) = {y}_{linear} ( t ) + {y}_{periodic} ( t ) \\ {y}_{linear} ( t ) = height ( t ) = {h}_{0} + drift * ( t - {t}_{0} ) \\ {y}_{periodic} ( t ) = Amplitude * sin ( Φ ( t ) ) , with Φ ( t ) = {Φ}_{0} + {ω}_{walk} * ( t - {t}_{0} )\end{matrix}$$

with height(t) the detected height of the eyes of the subject, h₀ the initial height of the person's eyes, drift the rate of change in this height (excluding any oscillation (“linear” component)), Amplitude the amplitude of the oscillation of the height of the eyes, Φ(t) the phase of the oscillation, do the initial phase and ω_{walk} the rate of change in this phase, i.e. the angular frequency of oscillation, which is in particular related to the pace of the steps of the person. The term “initial” here refers to a time t₀ of the end of the initialization phase.

Applying the extended Kalman filter to the two-observer model, it is then possible to write the state vector X(t) and the measurement vector Z(t) as follows:

$$X ( t ) \{ \begin{matrix}height ( t ) \\ \dot{height ( t )} = drift \\ Amplitude \\ Φ ( t ) \\ \dot{Φ ( t )} = {ω}_{walk}\end{matrix} , Z ( t ) = \{ \begin{matrix}\text{?} \\ \text{?}\end{matrix}$$

The module 303 for estimating the path of the eyes receives as input the three-dimensional positions of the eyes, which are computed at said computation frequency on the basis of one or more images captured by the context camera system. Each received three-dimensional position is a constituent of the instantaneous observable position signal [symbol] .

The instantaneous observable position signal is here processed so as to extract only its component along the y-axis: [symbol] to which is applied 303a a band-pass filter so as to isolate the non-linear part, which is assumed to be periodic, and in particular sinusoidal, of the component along the y-axis of the instantaneous observable position signal. The application frequency of the band-pass filter is for example 15 Hz, and it is in particular equal to the acquisition frequency, or less than the acquisition frequency so as to reduce processor load. Advantageously, the application frequency of the band-pass filter is variable, this making it possible to cope with cases of concealment of the subject, i.e. when the three-dimensional position cannot be computed in certain acquired images. The signal [symbol] therefore corresponds to the instantaneous observable position signal along the y-axis, for example as returned directly by two constituent stereoscopic cameras of the context camera system, and the signal [symbol] therefore corresponds to the periodic observable signal (centered on zero) extracted from the instantaneous observable position signal, as output from the band-pass filter fed with the y-axis component [symbol] of the instantaneous observable position signal [symbol] . The parameters of the band-pass filter will have been pre-calibrated by spectral analysis of trial data obtained from a sample of subjects, the same sample that made it possible to determine that the average oscillation frequency (in the y-direction) of a walking subject is between 1 and 2 Hz.

The phase 303b of initialization of the extended Kalman filter of the parametric path model comprises determining an initial state vector X(t₀) by determining initialization parameters comprising:
an amplitude parameter Amplitude;
a phase parameter P₀;
an angular-frequency parameter ω;
a rate-of-change parameter drift;
an intercept parameter P₀;
   said initialization parameters being determined from all or part of the sequence of computed three-dimensional positions of the region of interest in the detection volume. Preferably, the initialization parameters, forming the initial state vector X(t₀), are determined from the instantaneous observable position signal in such a way that the part of the sequence covers the captured “half first step” of the subject in the images acquired by the context camera system 105. To this end, the part of the sequence of positions comprises the positions computed for said region of interest on the basis of images acquired successively by the context camera system, the first image of which is the one in which the region of interest is detected a first time, and the following images of which are those in which the region of interest is detected, until at least two local extrema are detected.

This makes it possible to write the following equations of the extended Kalman filter:
the observation function;

$$h ( X ( t ) ) = \{ \begin{matrix}height ( t ) + Amplitude * sin ( Φ ( t ) ) \\ Amplitude * sin ( Φ ( t ) )\end{matrix}$$

and, for a length of time Tₛ from the last estimation, representing the variable sampling period;
the transition function (also known as the prediction function):

$$f ( X ( t ) ) = F ( {T}_{s} ) * X ( t ) = \{ \begin{matrix}height ( t ) + {T}_{s} * drift \\ drift \\ Amplitude \\ Φ ( t ) + {T}_{s} * {ω}_{walk} \\ {ω}_{walk}\end{matrix}$$

the transition matrix F and observation matrix H being defined as being Jacobians of f and h, respectively:

$$F ( {T}_{s} ) = [ \begin{matrix}1 & {T}_{s} & 0 & 0 & 0 \\ 0 & 1 & 0 & 0 & 0 \\ 0 & 0 & 1 & 0 & 0 \\ 0 & 0 & 0 & 1 & {T}_{s} \\ 0 & 0 & 0 & 0 & 1\end{matrix} ]$$

$$H ( t ) = [ \begin{matrix}1 & 0 & sin ( Φ ( t ) ) & Amplitude * cos ( Φ ( t ) ) & 0 \\ 0 & 0 & sin ( Φ ( t ) ) & Amplitude * cos ( Φ ( t ) ) & 0\end{matrix} ]$$

In each current time step a phase 303c of prediction of the state X(t+1) at the subsequent time takes place as does a phase 303d of updating the extended Kalman filter with respect to the measurement [symbol] of the current time step) and the prediction made in the previous time step.

In other words, during the prediction phase (also called the convergence phase) the state estimated at the previous time is used to produce an estimation of the current state:

$${\hat{X}}_{k \vert k - 1} = f ( {\hat{X}}_{k - 1 \vert k - 1} , {u}_{k} , 0 )$$

$$and$$

$${P}_{k \vert k - 1} = {F}_{k} {P}_{k - 1 \vert k - 1} {F}_{k}^{T} + {Q}_{k}$$

with P the error covariance matrix, i.e. here the covariance matrix of the measurement noise because there is considered to be no process noise, uₖ zero because the motion of the subject is not controlled, and Fₖ a matrix that relates the previous state k−1 to the current state k.

It is written:

$$P = [ \begin{matrix}{P}_{measure} & {P}_{measure \vert measure \_ bpf} \\ {P}_{measure \_ bpf \vert measure} & {P}_{measure \_ bpf}\end{matrix} ]$$

with, considering independent noises: P_{measure_bpf|measure}=0 and P_{measure|measure_bpf}=0, and the values of Pₘₑₐₛᵤᵣₑ and P_{measure_bpf} determined experimentally and statistically for the device 100 in question.

For a path estimation at constant frequency 1/Tₛ, the transition noise depends solely on the noise at said frequency (q_{drift} or q_{angular frequency})

$${Q}_{process} ( {q}_{drift} , {T}_{s} ) = {q}_{drift} * [ \begin{matrix}{T}_{s}^{3} / 3 & {T}_{s}^{2} / 2 \\ {T}_{s}^{2} / 2 & {T}_{s}\end{matrix} ]$$

$${Q}_{process} ( {q}_{angular frequency} , {T}_{s} ) = {q}_{angular frequency} * [ \begin{matrix}{T}_{s}^{3} / 3 & {T}_{s}^{2} / 2 \\ {T}_{s}^{2} / 2 & {T}_{s}\end{matrix} ]$$

The initial covariance (uncertainty) matrix Q of the transition noise of the model

$$Q ( {T}_{s} ) = [ \begin{matrix}{Q}_{process} ( {q}_{drift} , {T}_{s} ) & … & 0 \\ … & {q}_{a} & … \\ 0 & … & {Q}_{process} ( {q}_{angular frequency} , {T}_{s} )\end{matrix} ]$$

is calibrated based on:
the variance of the speed of the people in question: q_{drift} representing the change from one time to the next in the speed of a person (linear part of the prediction);
the variance q_{angular frequency} of the period of oscillation; and
the variance qₐ of the amplitude of oscillation;
   all three for example being preset empirically. In particular, the initial coefficients of the covariance matrix Q of the extended Kalman filter are obtained through successive iterations minimizing the error in the model on paths of the trials database.

In the phase 303c of prediction by the extended Kalman filter, provided that the prediction error |Pk/k−1−Pk/k| of the extended Kalman filter, in relation to the computation of the actual position, is greater that a convergence threshold, the extended Kalman filter is not considered to have converged. This check also ensures at each time step that the filter has not diverged. The convergence threshold is advantageously determined statistically or dynamically—it is for example of the order of one meter, or less, and in particular 0.2 m. Independently of the convergence of the filter, the prediction phase 303c continues with the update phase 303d.

In the update phase, the observations of the current time are used to correct the predicted state with the aim of obtaining a more accurate estimation:

$${\tilde{y}}_{k} = {z}_{k} - h ( {\hat{X}}_{k \vert k - 1} , 0 )$$

$${S}_{k} = {H}_{k} {P}_{k \vert k - 1} {H}_{k}^{T} + {R}_{k}$$

$${K}_{k} = {P}_{k \vert k - 1} + {K}_{k} {\tilde{y}}_{k}$$

$${\hat{X}}_{k \vert k} = {\hat{X}}_{k \vert k - 1} + {K}_{k} {\tilde{y}}_{k}$$

$${P}_{k \vert k} = ( I - {K}_{k} {H}_{k} ) {P}_{k \vert k - 1}$$

The matrix P is updated in each computation cycle corresponding to a new computation of position and gives the level of confidence in the path. Preferably, in case of loss of the region of interest (concealment), the filter is not updated and when the region of interest is again detected on a subsequent acquisition, the filter is updated with the sampling period corresponding to the length of time between the time when the region of interest was acquired (and de facto its position computed) last and the time when the region of interest was again acquired.

If the extended Kalman filter has converged, the estimation of the path of the region of interest at said future time tracking is obtained by computing the tangent to the path modeled on the basis of the acquisitions made up to the time of the last acquisition t_{measure position} used to update the extended Kalman filter (i.e. including the region of interest), in particular by writing the modeled path in the form of a position pos and speed spd:

$$pos ( {t}_{tracking} ) = {P}_{average path} ( {t}_{measure position} ) + {drift}_{average path} * ( {t}_{tracking} - {t}_{measure position} ) + Amplitude * sin ( Φ ( {t}_{measure position} ) + ω * ( {t}_{tracking} - {t}_{measure position} )$$

$$spd ( {t}_{tracking} ) = {drift}_{average path} + Amplitude * ω * cos ( Φ ( {t}_{measure position} ) + ω * ( {t}_{tracking} - {t}_{measure position} ) .$$

If t_{tracking} is selected to be the estimated time of receipt of said path estimated by the real-time coprocessor 202, this makes it possible to compensate for the latency between the real times and the last acquisition used to update the extended Kalman filter.

The estimation of the path in the y-dimension of the eyes at a given time t_{tracking} of receipt by the path-tracking module 304 is obtained by computing the tangent to the modeled path and is written:

$$pos ( t ) = pos ( {t}_{tracking} ) + spd ( {t}_{tracking} ) * ( t - {t}_{tracking} )$$

The path in the other two dimensions is for example obtained using the model described in connection with the additional path estimation.

Thus, at the current time, the camera is commanded to point toward the coordinates of the position pos (t_{capture}) of the region of interest estimated for the future time t_{capture} by applying the preceding equation to the time t_{capture}, this making it possible to compensate for the response time of the pointing system 305 and/or focusing system 307 of the capture camera.

To obtain a reliable path estimation, it is necessary to sample the position computation at a sufficient frequency. This frequency will depend on the speed of movement of the subject and therefore depend on the envisioned application. For example, in the case of recognition of the irises of a walking person, a frequency of 15 context images and therefore of 15 computed position estimations per second has proved sufficient, the same going for the path estimation.

FIG. 6 shows one example of a data-processing device 106 for implementing one or more embodiments of the invention. The data-processing device 106 typically comprises one or more central processing units (CPUs) 601 and/or one or more graphics processing units (GPUs) 605, a physical communication module (NET) 604, one or more physical input/output modules 607 for interchanging data with external devices (such as the context camera system and the capture camera), a transient storage medium 602 such as a random access memory (RAM), a non-transient recording medium 603 (FLASH) and communication buses (not shown) for transferring data between the internal components of the data-processing device 106.

The data-processing device 106 may be used to execute one or more program modules 301, 302, 303, 304, 305, 306, 307 comprising instructions that, when the program module or modules are executed, cause the data-processing device 106 to carry out the method according to the invention. The program module or modules may be written in any, compiled or interpreted, programming language. They may form part of a software solution, i.e. of a collection of executable instructions, of codes, of scripts or the like and/or of databases.

The data-processing device 106 comprises the following elements, connected to each other via a communication bus:
a central processing unit (CPU) 601, such as a microprocessor, and including in particular an internal clock;
a transient memory 602, for storing the executable code of the method for carrying out the invention and registers configured to record variables and parameters required to implement the method according to embodiments of the invention; the memory capacity of the device is preferably supplemented by an optional random-access memory 602 connected to an extension port, for example;
a non-transient memory 603 for storing the computer programs and calibration data needed to implement embodiments of the invention; the stored computer programs in particular comprise a computer program comprising instructions configured to implement all or some of the steps of the method according to the invention when said program is executed on the processing device 106, said non-transient memory 603 then being one example of a (removable or irremovable) non-transient information storage means;
a communication module 604 comprising a network interface 604 connected to a communication network over which digital data to be processed are transmitted or received; the network interface 604 may be a single network interface, or be made up of a set of different network interfaces (for example wired and wireless interfaces or different types of wired or wireless interfaces). Data packets are sent to the network interface for transmission or are read from the network interface when received under control of the software application executed in the processor 601;
a user interface (HMI), in particular one comprising a graphics processor 605, for receiving inputs from a user or for displaying information to a user, in particular (visual and/or vocal) guidance information;
an input/output module 607 for receiving/sending data from/to external peripherals such as a hard disk, a removable storage media, inter alia.

The executable code may be stored in the non-transient memory 603, for example a flash memory or a read-only memory, or on a removable digital medium such as, for example, a disk. According to one variant, the executable code of the programs may be received by means of a communication network, via the network interface 604, in order to be stored in one of the storage means of the data-processing device 106, such as the memory 603, before being executed.

The central processing unit 601 is configured to control and direct execution of the instructions or of segments of software code of the program or programs according to one of the embodiments of the invention, which instructions are stored in one of the aforementioned storage means, such as the non-transient memory 603. After being turned on, the CPU 601 is capable of executing instructions from the transient RAM memory 602 that relate to a software application. Such software, when executed by the processor 601, allows the method according to the invention to be executed.

In one embodiment, the device is a programmable device that uses software to implement the invention. As a variant, the present invention may be implemented in hardware form (for example, in the form of an application-specific integrated circuit (ASIC) or in the form of a field-programmable gate array (FPGA)).

According to one embodiment, the data-processing device 106 is solely hosted locally, or, as a variant, is external to the terminal 1, or even distributed and comprises multiple processing sub-units, which in particular are at least partly external and communicate with one another via the network interface 604. Similarly, depending in particular on the nature of the terminal, all or part of the memory may be physically remote, hosted for example on a remote server.

1. A method for capturing images of a region of interest of a moving subject (103) within a capture volume, the method comprising the following steps:
computation, repeated at a computation frequency, of a three-dimensional position of the region of interest, delivering as output a sequence of three-dimensional positions of the region of interest, on which an instantaneous observable position signal [symbol] depends, from a series of acquired images in which the region of interest is detected and located;
extraction, at an application frequency, of a periodic observable signal [symbol] from the instantaneous observable position signal [symbol] ;
estimation of a three-dimensional path (P_{eyes}(t)) of the region of interest in the capture volume from the computed positions, the path being defined, in at least one dimension, by a parametric path model combining a periodic temporal component (P_{periodic}(t)) and a linear temporal component (Pₗᵢₙₑₐᵣ(t));
determination of a position of the region of interest at least at one future time t_{capture} from the estimated three-dimensional path of the region of interest;
capture, at the time t_{capture}, of an image of the region of interest by a capture camera with the capture camera pointing in the direction of the determined position of the region of interest at the time t_{capture}.

2. The method as claimed in claim 1, wherein the subject is a person, the region of interest being a portion of a face of the moving subject, in particular an eye, preferably an iris, or being a visual representation worn by the subject, such as a two-dimensional bar code.

3. The method as claimed in claim 1, wherein the step of estimation of the path (P_{eyes}(t)) comprises implementation, for the detected region of interest of the subject, of an extended Kalman filter of the parametric path model in said at least one dimension, this comprising a phase of initialization of the extended Kalman filter, a phase of prediction by the extended Kalman filter and a phase of update of the extended Kalman filter at a sampling frequency.

4. The method as claimed in claim 1, comprising a step of application, at the application frequency, of a band-pass filter in said at least one dimension to the instantaneous observable position signal [symbol] with a view to extracting the periodic observable signal [symbol] .

5. The method as claimed in claim 3, wherein the extended Kalman filter is based on a measurement vector
$$( Z ( t ) = \{ \begin{matrix}\text{?} \\ \text{?}\end{matrix} )$$
containing at least two observers, having as first observer the instantaneous observable position signal, which is made up of the sequence of computed positions of the region of interest, and as second observer the periodic observable signal.

6. The method as claimed in claim 3, wherein a state vector of the extended Kalman filter
$$( X ( t ) = \{ \begin{matrix}{P}_{average path} ( t ) \\ \dot{{P}_{average path}} ( t ) = {drift}_{average path} \\ Amplitude \\ Φ ( t ) \\ \dot{Φ ( t )} = ω\end{matrix} )$$
contains five states, namely an average position of the region of interest in said at least one dimension (P_{average path}(t)), a rate of change
$$( \dot{{P}_{average path}} ( t ) )$$
in the average position of the region of interest in said at least one dimension, an amplitude (Amplitude) of oscillation of the region of interest around the average position, a phase (Φ(t)) of oscillation around the average position and an angular frequency (Φ(t)) of oscillation of the average position of the region of interest.

7. The method as claimed in claim 3, wherein the phase of initialization of the filter comprises determining an initial state vector (X(t₀)) through determination of initialization parameters comprising:
an amplitude parameter (Amplitude);
a phase parameter (Φ₀);
an angular-frequency parameter (ω);
a rate-of-change parameter (drift);
an intercept parameter (P₀);
said initialization parameters being determined from all or part of the sequence of computed three-dimensional positions of the region of interest.

8. The method as claimed in claim 7, wherein said part of the sequence of positions comprises the positions computed for said region of interest on the basis of successively acquired images, the first image of which is the one in which the region of interest is detected a first time, and the following images of which are those in which the region of interest is detected, until at least two local extrema are detected.

9. The method as claimed in claim 3, wherein a covariance matrix of the process noise (Q) of the extended Kalman filter depends on the sampling period (Tₛ) of the extended Kalman filter and on at least one variance (q_{drift}) of the rate of change
$$( \dot{{P}_{average path}} ( t ) )$$
in the average position of the region of interest in said at least one dimension, a variance (q_{angular frequency}) of the angular frequency of oscillation (Φ(t)) of the region of interest around the average position of the region of interest or a variance (q_{α}) of the amplitude of oscillation (Amplitude) of the region of interest around the average position of the region of interest.

10. The method as claimed in claim 3, wherein the estimation of the path of the region of interest at an arbitrary future time t_{tracking} is obtained by computing a tangent to the modeled path at said arbitrary future time t_{tracking} and the parameters of which result from the update of the extended Kalman filter on the basis of images acquired prior to the estimation, in particular with the modeled path written in terms of position pos and speed spd as:
$$pos ( {t}_{tracking} ) = {P}_{average path} ( {t}_{measure position} ) + {drift}_{average path} * ( {t}_{tracking} - {t}_{measure position} ) + Amplitude * sin ( Φ ( {t}_{measure position} ) + ω * ( {t}_{tracking} - {t}_{measure position} )$$
$$spd ( {t}_{tracking} ) = {drift}_{average path} + Amplitude * ω * cos ( Φ ( {t}_{measure position} ) + ω * ( {t}_{tracking} - {t}_{measure position} ) ,$$
with t_{measure position} the time at which the last context image used to estimate the path is acquired, the tangent to the parametric model being written:
$$pos ( t ) = pos ( {t}_{tracking} ) + spd ( {t}_{tracking} ) * ( t - {t}_{tracking} ) .$$

11. The method as claimed in claim 1, wherein the capture camera is pointed in the direction of the position of the region of interest determined depending on the three-dimensional path of the region of interest at a frequency higher than the computation frequency.

12. A computer program comprising instructions configured to implement each of the steps of the method as claimed in claim 1 when said program is executed on a computer.

13. A non-transitory computer-readable medium that stores code instructions of a computer program for causing a computer or microprocessor to execute the method as claimed in claim 1.

14. A device for capturing images of a region of interest of a moving subject within a capture volume, the device comprising:
a context camera system;
a capture camera;
a processor configured for the following steps:
computation, repeated at a computation frequency, of a three-dimensional position of the region of interest, delivering as output a sequence of three-dimensional positions of the region of interest, on which an instantaneous observable position signal [symbol] depends, from a series of images acquired by the context camera system and in which the region of interest is detected and located;
extraction, at an application frequency, of a periodic observable signal [symbol] from the instantaneous observable position signal [symbol] ;
estimation of a three-dimensional path (P_{eyes}(t)) of the region of interest in the capture volume from the computed positions, the path being defined, in at least one dimension, by a parametric path model combining a periodic temporal component (P_{periodic}(t)) and a linear temporal component (Pₗᵢₙₑₐᵣ(t));
determination of a position of the region of interest at least at one future time t_{capture} from the estimated three-dimensional path of the region of interest;
capture, at the time t_{capture}, of an image of the region of interest with the capture camera pointing in the direction of the determined position of the region of interest at the time t_{capture}.

15. The device as claimed in claim 14, wherein the capture camera is rotatable so as to point in the direction of the determined position of the region of interest in said at least one dimension.

16. The device as claimed in claim 14, wherein the subject is a person, the region of interest being a portion of a face of the moving subject, in particular an eye, preferably an iris, or being a visual representation worn by the subject, such as a two-dimensional bar code.

17. The device as claimed in claim 14, wherein the estimation of the path (P_{eyes}(t)) comprises implementation, for the detected region of interest of the subject, of an extended Kalman filter of the parametric path model in said at least one dimension, this comprising a phase of initialization of the extended Kalman filter, a phase of prediction by the extended Kalman filter and a phase of update of the extended Kalman filter at a sampling frequency.

18. The device as claimed in claim 17, wherein the extended Kalman filter is based on a measurement vector
$$( Z ( t ) = \{ \begin{matrix}\text{?} \\ \text{?}\end{matrix} )$$
containing at least two observers, having as first observer the instantaneous observable position signal, which is made up of the sequence of computed positions of the region of interest, and as second observer the periodic observable signal.

19. The device as claimed in claim 17, wherein a state vector of the extended Kalman filter
$$( X ( t ) = \{ \begin{matrix}{P}_{average path} ( t ) \\ \dot{{P}_{average path}} ( t ) = {drift}_{average path} \\ Amplitude \\ Φ ( t ) \\ \dot{Φ ( t )} = ω\end{matrix} )$$
contains five states, namely an average position of the region of interest in said at least one dimension (P_{average path}(t)), a rate of change
$$( \dot{{P}_{average path}} ( t ) )$$
in the average position of the region of interest in said at least one dimension, an amplitude (Amplitude) of oscillation of the region of interest around the average position, a phase (Φ(t)) of oscillation around the average position and an angular frequency (Φ(t)) of oscillation of the average position of the region of interest.

20. The device as claimed in claim 14, the processor being further configured to perform a step of application, at the application frequency, of a band-pass filter in said at least one dimension to the instantaneous observable position signal [symbol] with a view to extracting the periodic observable signal [symbol] .
